(19) United States
(12) Patent Application Publication
(10) Pub. No.: US 2005/0089452 A1
(43) Pub. Date: Apr. 28, 2005

(54) Structure of a light-catalyst mechanism of an air cleaner

(76) Inventor: Ping Huang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/690,701

(22) Filed: Oct. 23, 2003

(51) Int. Cl. B01J 19/08; A62B 7/08

(52) U.S. Cl. 422/121; 422/186

(57) ABSTRACT

A light-catalyst mechanism of an air cleaner includes light tubes disposed in a holding room of the air cleaner, and a filtering honeycomb net disposed in the holding room; the filtering honeycomb net has titanium dioxide applied over it; a supporting frame is fixedly disposed in the holding room; the light tubes are secured to the supporting frame at two ends thereof; a separating frame is disposed around the supporting frame to keep the light tubes and the filtering honeycomb net a distance apart; thus, when the air cleaner and the light tubes are activated, air will pass through the filtering honeycomb net to be purified with germs therein being killed, bad odors got rid of, and detrimental substances decomposed.

### BACKGROUND OF THE INVENTION

1. Field of the invention

The present invention relates to a light-catalyst mechanism of an air cleaner for getting rid of bad odor, killing germs, and decomposing detrimental substances in the air, more particularly one, which has a simple structure, and is easy to manufacture and assemble.

2. Brief Description of the Prior Art will When titanium dioxide (TiO₂), a kind of light catalyst, meets ultraviolet light, it will be excited by the photons, and effect chemical reaction of air therewith so that detrimental substances in the air are decomposed into non-harmful ones. With such reaction, germs in the air can be killed, unpleasant odor got rid of, and exhaust of cars and factories decomposed, and in turns, air is purified. TiO₂ has been applied for such purpose on some kinds of home appliances, e.g. air filters, air purifiers, air conditioners, and electric fans, to improve the quality of air in the environment; the above appliances are usually equipped with a light-catalyst mechanism, which is comprised of a light tube capable of emitting ultraviolet light, and a light-catalyst member having TiO₂ applied over it, so that when the appliances are activated, ultraviolet light will shine on the TiO₂ applied over the light-catalyst member, and in turns, air passing through the appliances is purified, and germs in the air killed.

However, conventional light-catalyst mechanisms have relatively complicated structures, and are expensive, and not easy to assemble. Consequently, the prices of air filtering and purifying appliances equipped with light-catalyst mechanisms are relatively high.

### SUMMARY OF THE INVENTION

It is a main object of the present invention to provide a light-catalyst mechanism of an air cleaner, which has a simple structure, and is easy to manufacture and assemble.

The present light-catalyst mechanism is comprised of light tubes disposed in a holding room of an air cleaner, a filtering honeycomb net, which is disposed in the holding room, and which has titanium dioxide applied over it. A supporting frame is fixedly disposed in the holding room; the supporting frame has gaps thereon. The light tubes are securely fitted in the gaps of the supporting frame at two ends thereof. A separating frame is disposed around the supporting frame to keep the light tubes and the filtering honeycomb net apart. A front protecting net disposed over a front opening of the air cleaner to protect the filtering honeycomb net.

### BRIEF DESCRIPTION OF THE DRAWINGS

This invention will be better understood by referring to the accompanying drawings, wherein:

FIG. 1 is an exploded perspective view of the air cleaner according to the present invention,

FIG. 2 is a perspective view of the air cleaner according to the present invention, without the front protecting net,

FIG. 3 is a front view of the air cleaner of the present invention,

FIG. 4 is a vertical section of the air cleaner according to the present invention, and

FIG. 5 is a partial vertical section of the air cleaner according to the present invention.

### DETAILED DESCRIPTION OF THE PREFERRED EMBODIMENTS

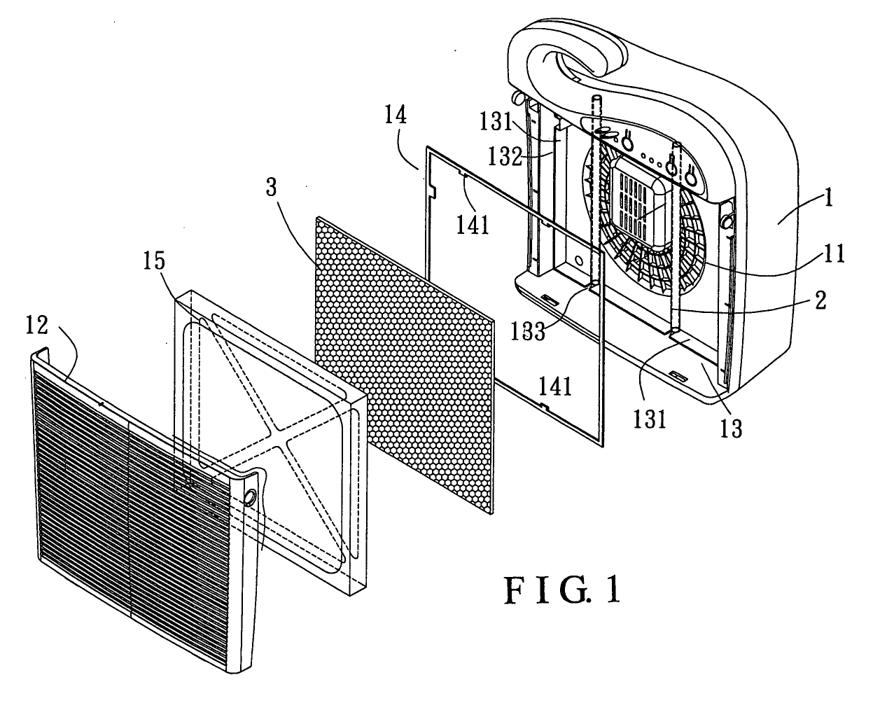

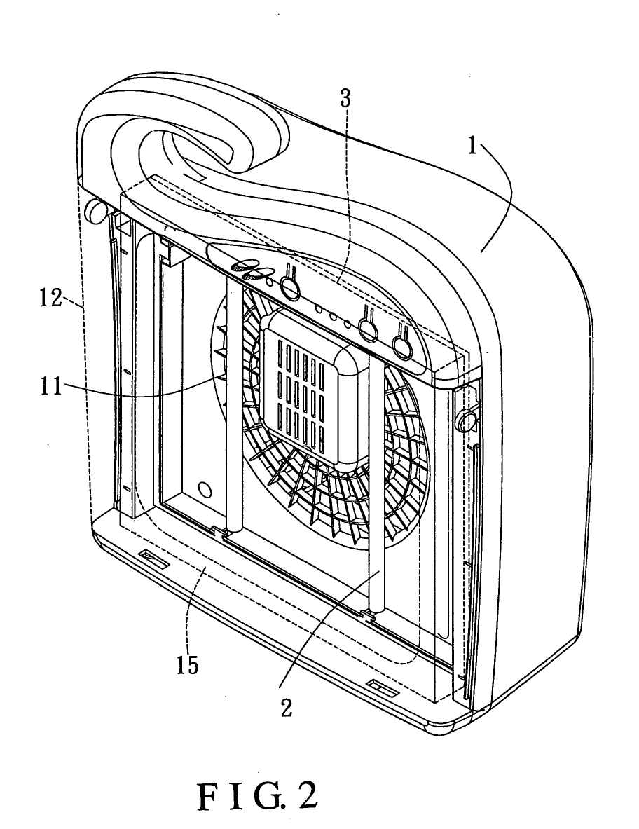

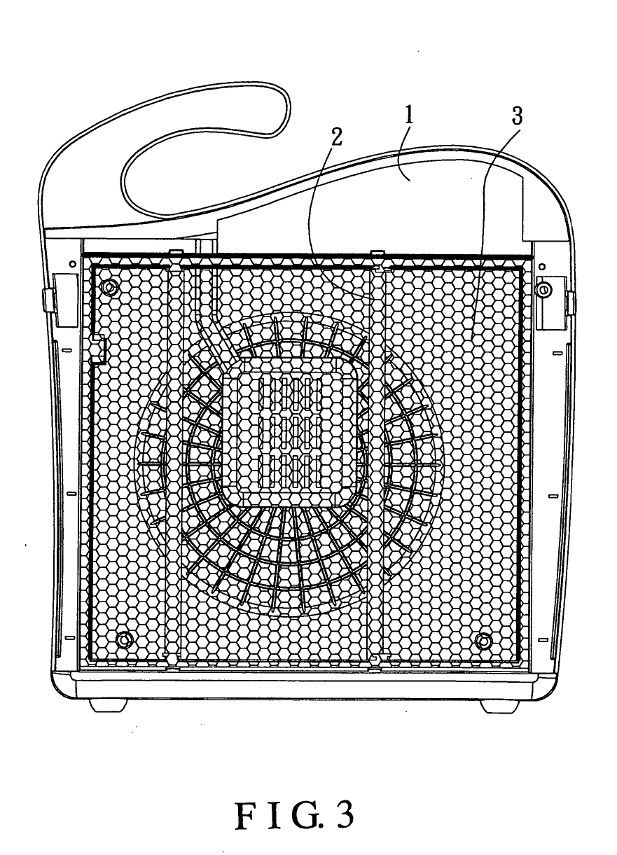

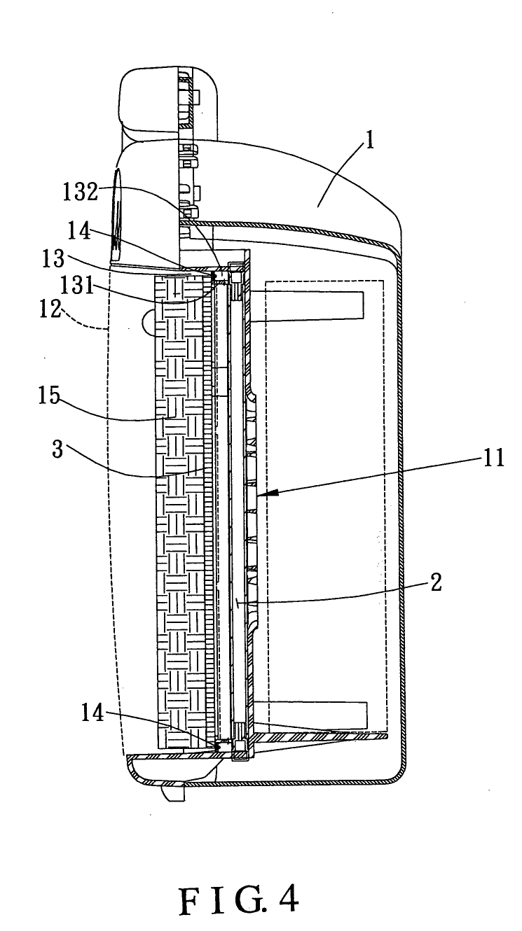

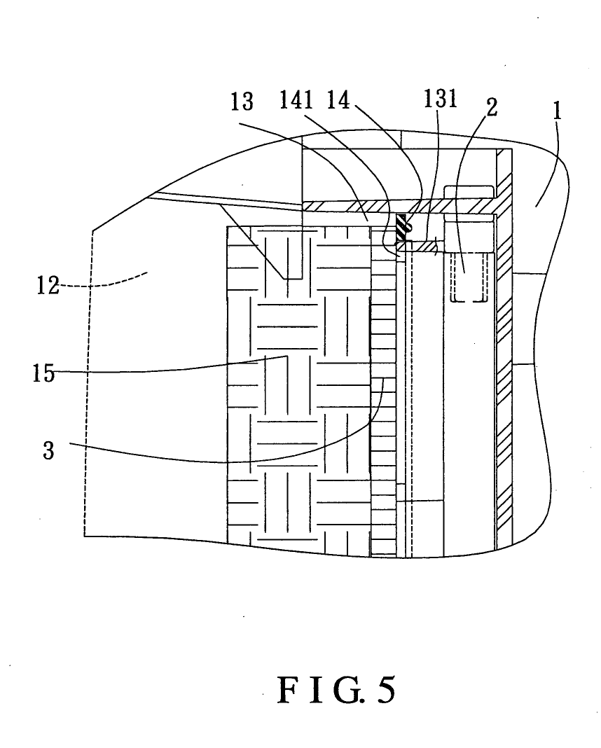

Referring to FIGS. 1 to 5, a preferred embodiment of an air cleaner in the present invention includes a main body 1, and a light-catalyst mechanism, which is comprised of light tubes 2, and a filtering honeycomb net 3.

The air cleaner main body 1 has an air passage 11 in front of a cleaning mechanism thereof (not shown) for air to travel through. And, the inside structure of the air cleaner main body 1 is not the subject of the present invention therefore it won't be detailed in this disclosure. The main body 1 further has a holding room 13 in a front portion, and a front protecting net 12 disposed over a front opening thereof. A supporting frame 131 is fixedly disposed in the holding room 13 such that elongated spaces 132 are formed between it and edges of the main body 1. The supporting frame 131 has gaps 133 thereon.

The light tubes 2 of the light-catalyst mechanism are securely fitted in the gaps 133 of the supporting frame 131 at two ends thereof while wires (not shown), which connect the light tubes 2 to the power supply, are hidden in the elongated spaces 132; the light tubes 2 are preferably ultraviolet light tubes. And, a separating frame 14 is disposed in front of the light tubes 2, and is disposed around the supporting frame 131 to cover the elongated spaces 132; the separating frame 14 has stopping protrusions 141 thereon, which are tightly fitted into respective ones of the gaps 133.

The filtering honeycomb net 3 has titanium dioxide (TiO₂), a kind of light catalyst, applied over it, and is disposed in front of the separating frame 14 inside the holding room 13; thus, the filtering honeycomb net 3 and the light tubes 2 are kept a suitable distance apart by the separating frame 14, and the stopping protrusions 141 will separate the filtering honeycomb net 3 and the light tubes 2 effectively to prevent danger. Furthermore, a filter 15 is disposed in front of, and secured to the filtering honeycomb net 3 inside the holding room 13; the filter 15 can be disposed next to the air passage 11 of the main body 1 instead, and can be ordinary filters used on conventional air purifiers, which are comprised of a front electrostatic filtering member, and active carbon secured to a rear side of the front electrostatic filtering member. And, the front protecting net 12 is disposed in front of the filter 15; the filter 15 can be secured to the front protecting net 12 instead.

Thus, when the air cleaner and the light tubes 2 are activated, air will be first cleaned by the main body 1, and ultraviolet light will shine on the titanium dioxide (TiO₂) over the filtering honeycomb net 3. Then, the air will pass through the filtering honeycomb net 3 to be purified with germs therein being killed, bad odors got rid of, and detrimental substances decomposed. Finally, the air travels outside through the filter 15 and the front protecting net 12.

From the above description, it can be seen that the light-catalyst mechanism of an air cleaner of the present invention has a simple structure, and is easy to assemble. Therefore, when an air cleaner is equipped with the present light-catalyst mechanism, there won't be significant increase of production cost.

1. A light-catalyst mechanism of an air cleaner, comprising
a plurality of light tubes disposed in front of an air passage of a main body of the air cleaner within a holding room of the air cleaner;
a filtering honeycomb net disposed in the holding room; the filtering honeycomb net having titanium dioxide applied over it;
a supporting frame fixedly disposed in the holding room so that elongated spaces are formed between it and edges of the main body; the supporting frame having gaps thereon; the light tubes being securely fitted in the gaps of the supporting frame at two ends thereof; wires, which connect the light tubes to a power supply, being hidden in the elongated spaces; and
a separating frame disposed around the supporting frame to cover the elongated spaces and to keep the light tubes and the filtering honeycomb net apart.

2. The light-catalyst mechanism of an air cleaner, wherein the separating frame has stopping protrusions thereon, which are fitted into respective ones of the gaps of the supporting frame to ensure separation of the filtering honeycomb net from the light tubes.
